(19) United States
(12) Patent Application Publication
(10) Pub. No.: US 2019/0337968 A1
(43) Pub. Date: Nov. 7, 2019

(54) METHOD FOR PRODUCING HALOSILANE COMPOUNDS

(71) Applicant: Milliken & Company, Spartanburg, SC (US)

(72) Inventors: Cliferson Thivierge, Gainesville, FL (US); Robbie W.J.M. Hanssen, Boiling Springs, SC (US); Eduardo Torres, Greer, SC (US); Christopher K. Baucom, Alachua, FL (US); Brian M. Burkhart, Greer, SC (US)

(21) Appl. No.: 16/392,172

(22) Filed: Apr. 23, 2019

Related U.S. Application Data
(60) Provisional application No. 62/665,266, filed on May 1, 2018.

(51) Int. Cl. C07F 7/14

(52) U.S. Cl. CPC C07F 7/14

(57) ABSTRACT

A method for making a halosilane compound comprises the steps of: (a) providing a first halosilane compound, (b) providing a reaction vessel containing a halide source disposed inside, (c) feeding the halosilane compound into the reaction vessel, and (d) collecting a product stream from the reaction vessel, where the product stream contains a second halosilane.

### CROSS-REFERENCE TO RELATED PATENT APPLICATIONS

This application claims, pursuant to 35 U.S.C. § 119(e), priority to and the benefit of the filing date of U.S. patent application Ser. No. 62/665,266 filed on May 1, 2018, the contents of which are hereby incorporated by reference.

### TECHNICAL FIELD OF THE INVENTION

This application relates to a method for producing high purity halosilane compounds in high yields.

### BACKGROUND

Halosilane compounds are used in a variety of industrial applications. For example, halosilane compounds (e.g., chlorosilanes) are used in the manufacture of polycrystalline silicon destined for photovoltaic and electronics applications (e.g., semiconductor wafers). Recently, these industries have begun to use higher halosilane compounds (e.g., iodosilanes) as an alternative to chlorosilanes. These higher halosilane compounds are generally more difficult to manufacture than the lower halosilane compounds (e.g., chlorosilanes), especially with the purity levels demanded by photovoltaic and electronics industries. For instance, known processes for synthesizing such higher halosilanes generally are performed in organic solvents. This requires one to isolate the desired halosilane compound from the organic solvent after the reaction is performed. Such separation/isolation processes can be tedious, especially when one is required to reduce solvent contamination to the extremely low levels demanded by photovoltaic and electronics industries

A need therefore remains for a method of manufacturing halosilane compounds, especially higher halosilane compounds, that is commercially viable on an industrial scale and produces halosilane compounds at the high purities demanded by industry. A need further remains for a method that is not performed in organic solvents and therefore avoids the need to remove such solvents from the halosilane compound(s) produced. The method described herein is believed to meet all these needs.

### BRIEF SUMMARY OF THE INVENTION

In a first embodiment, the invention provides a method for producing halosilane compounds, the method comprising the steps of:

(a) providing a first halosilane compound, the first halosilane compound comprising a first halogen covalently bound to a silicon atom;

(b) providing a reaction vessel having an inlet, an outlet, and an interior volume, the reaction vessel containing a halide source disposed in the interior volume, the halide source comprising a second halogen having a greater atomic number than the first halogen;

(c) feeding the first halosilane compound into the inlet of the reaction vessel and through the interior volume of the reaction vessel so that it contacts the halide source and reacts to form a second halosilane compound, the second halosilane compound comprising at least one second halogen covalently bound to a silicon atom; and

(d) collecting a product stream from the outlet of the reaction vessel, the product stream comprising the second halosilane compound.

### DETAILED DESCRIPTION OF THE INVENTION

In a first embodiment, the invention provides a method for producing halosilane compounds. The method generally entails passing a first halosilane compound through a reaction vessel containing a halide source. The first halosilane compound preferably is fluid (i.e., a liquid or a gas) when it is fed into the reaction vessel. The first halosilane compound and the halide source react to produce a second halosilane compound that is different from the first compound (i.e., the second halosilane compound contains at least one halogen that was not present in the first halosilane compound). The second halosilane compound is then collected from an outlet of the reaction vessel. More specifically, the method comprises the steps of: (a) providing a first halosilane compound, (b) providing a reaction vessel containing a halide source disposed inside, (c) feeding the halosilane compound into the reaction vessel, and (d) collecting a product stream from the reaction vessel, where the product stream contains the second halosilane.

The first halosilane compound preferably comprises at least one first halogen covalently bound to a silicon atom of the halosilane compound. The first halosilane compound can be any suitable halosilane compound possessing such a halogen. In a preferred embodiment, the first halosilane compound is selected from the group consisting of chlorosilanes, bromosilanes, and mixtures thereof. Preferably, the first halosilane compound is a compound of Formula (I), Formula (X), Formula (XX), or Formula (XL) as shown below. The structure of Formula (I) is

SiₐH_{b}R_{c}X_{d} Formula (I).

In the structure of Formula (I), the variable a is an integer from 1 to 3. The sum of variables b, c, and d is 2a+2. The variable b is an integer from 0 to 2a+1, preferably an integer from 1 to 2a+1. The variable c is an integer from 0 to 2a+1, and the variable d is an integer from 1 to 2a+2. The structure of Formula (X) is

N(SiHₑR_{f}X_{g})₃ Formula (X).

In the structure of Formula (X), the sum of e, f, and g attached to each silicon atom is equal to 3. Each variable e is an independently selected integer from 0 to 3, and preferably at least one variable e is 1 or greater (i.e., 1 to 3). Each variable f is an independently selected integer from 0 to 3, and each variable g is an independently selected integer from 0 to 3. In the structure of Formula (X), at least one variable g is 1 or greater. The structure of Formula (XX) is

(SiHₛRₜXᵥ)₂CH₂ Formula (XX).

In the structure of Formula (XX), the sum of s, t, and v attached to each silicon atom is equal to 3. Each s is an independently selected integer from 0 to 3, and preferably at least one variable s is 1 or greater (i.e., 1 to 3). Each variable t is an independently selected integer from 0 to 3. Each variable v is an independently selected integer from 0 to 3. In the structure of Formula (XX), at least one variable v is 1 or greater. The structure of Formula (XL) is

(HₘRₙXₚSiO)_{q}SiHₘRₙXₚ Formula (XL).

In the structure of Formula (XL), the sum of m, n, and p attached to each silicon atom is equal to 3. Each m is an independently selected integer from 0 to 3, and preferably at least one variable m is 1 or greater (i.e., 1 to 3). Each variable n is an independently selected integer from 0 to 3. Each variable p is an independently selected integer from 0 to 3. In the structure of Formula (XL), at least one variable p is 1 or greater. The variable q is an integer from 1 to 50.

In the structures of Formula (I), Formula (X), Formula (XX), and Formula (XL), each R is independently selected from the group consisting of hydrocarbyl groups and ZR¹₃ groups, each Z is independently selected from silicon and germanium (with silicon being particularly preferred), each R¹ is independently selected from hydrogen and hydrocarbyl groups; and each X is independently selected from chlorine and bromine. In a preferred embodiment, each R group is independently selected from the group consisting of alkyl groups (e.g., C₁-C₁₀ alkyl groups). More preferably, each R group is independently selected from the group consisting of C₁-C₄ alkyl groups, with methyl groups being particularly preferred. In another preferred embodiment, each R¹ group is independently selected from the group consisting of alkyl groups (e.g., C₁-C₁₀ alkyl groups). More preferably, each R¹ group is independently selected from the group consisting of C₁-C₄ alkyl groups, with methyl groups being particularly preferred. In a preferred embodiment, the first halosilane compound of Formula (I), Formula (X), Formula (XX), or Formula (XL) contains at least one X that is chlorine.

In one preferred embodiment of the method, the first halosilane compound is dichlorosilane. In another preferred embodiment of the method, the first halosilane compound is trichlorosilane. In yet another preferred embodiment, the first halosilane compound is silicon tetrachloride (tetrachlorosilane). In another preferred embodiment, the first halosilane compound is pentachlorodisilane. In an alternative preferred embodiment, the first halosilane compound is 1-chloro-N,N-disilyl-silanamine. In one preferred embodiment, the first halosilane compound is an alkylchlorosilane, such as chlorotrimethylsilane. In another preferred embodiment, the first halosilane compound is an alkyldichlorosilane, more preferably methyldichlorosilane. In an alternative preferred embodiment, the first halosilane compound is a dialkyldichlorosilane, more preferably dimethyldichlorosilane. In yet another preferred embodiment, the first halosilane compound is an arylchlorosilane, such as trichlorophenylsilane or chloromethylphenylvinylsilane. In another preferred embodiment, the first halosilane compound is a chlorodisiloxane, such as dichlorotetramethyldisiloxane.

The method of the invention utilizes a reaction vessel in which at least a portion of the first halosilane compound is converted to a second halosilane compound. The reaction vessel preferably comprises an inlet, an outlet, and an interior volume. The inlet and the outlet preferably are connected to the interior volume such that a material (e.g., a fluid) passing through the inlet enters the interior volume of the reaction vessel where it is retained until it passes out of the interior volume through the outlet. The inlet and the outlet can be in any suitable position relative to one another. Preferably, to ensure adequate residence of the first halosilane compound in the reaction vessel, the inlet and the outlet are, relative to one another, positioned at substantially opposite ends of the interior volume. The reaction vessel can be any suitable vessel having the characteristics described above. For example, in one potential embodiment, the reaction vessel preferably is a tube having an inlet at one end, an outlet at the opposite end, and an interior volume disposed therebetween. The reaction vessel can be constructed from any suitable material. Preferably, the reaction vessel is constructed from a material that is inert to the first halosilane, the halide source, and the second halosilane.

The reaction vessel contains a halide source disposed in its interior volume. The halide source can be any suitable source of a halide capable of reacting with the first halosilane compound as described herein. The halide source can be a solid (i.e., a solid halide source) or a fluid, such as a liquid. Suitable liquid halide sources include, but are not limited to, ionic liquids containing a halogen as described herein. As used herein, the term “solid halide source” refers to a halide source that is solid at the reaction temperature (i.e., the temperature at which the first halosilane compound and halide source react to form the second halosilane compound). Preferably, the halide source comprises a halogen that has a greater atomic number than at least one halogen in the first halosilane compound. The halide source can contain more than one halogen (i.e., two or more different halogens). When the halide source contains more than one halogen, at least one of those halogens preferably has an atomic number that is greater than the atomic number of at least one halogen in the first halosilane compound. In a preferred embodiment, the halide source is selected from the group consisting of anhydrous bromide salts, anhydrous iodide salts, and mixtures thereof. In another preferred embodiment, the halide source is selected from the group consisting of alkali metal halides, alkaline earth metal halides, and mixtures thereof. In a preferred embodiment, the halide source is an anhydrous halide salt (i.e., a crystalline halide salt containing no waters of hydration). As described herein, anhydrous halide salts may contain modest amounts of free moisture, such as about 10 wt. % or less, about 5 wt. % or less, about 4 wt. % or less, about 3 wt. % or less, about 2 wt. % or less, or about 1 wt. % or less water. In one preferred embodiment, the halide source is a bromide salt, more preferably an anhydrous bromide salt. In one particular preferred embodiment, the halide source is lithium bromide, more preferably anhydrous lithium bromide. In one preferred embodiment, the halide source is an iodide salt, more preferably an anhydrous iodide salt. In another preferred embodiment, the halide source is selected from the group consisting of lithium iodide, magnesium iodide, and mixtures thereof. Preferably, the halide source is lithium iodide, more preferably anhydrous lithium iodide.

The reaction vessel can contain any suitable amount of the halide source. In certain embodiments, the reaction vessel can contain an inert filler (i.e., a filler that is not reactive to the first halosilane compound, the halide source, or the second halosilane compound) in addition to the halide source. While such inert fillers can be used, their use will decrease the amount of halide source that is available to react with the first halosilane compound. In a system in which halide source is not continually added to the reactor, the use of a filler will decrease the amount of second halosilane compound that can be produced before the reaction vessel must be disconnected, emptied, and refilled with halide source before the process can be resumed. Preferably, the reaction vessel contains enough halide source to substantially fill the interior volume of the reaction vessel. As used in this context, the term “substantially fill” means that the interior volume of the reaction vessel is filled with halide source, with the only unoccupied volume being the interstices between adjacent grains of the halide source. The combined volume of these interstices will depend upon several factors, such as the grain/particle size of the halide source and the geometry of the grains/particles of the halide source.

During the method, the reaction vessel can be maintained at any suitable temperature at which the reaction between the first halosilane compound and the halide source will occur. The reaction vessel typically is maintained at and the reaction is carried out at a temperature and pressure at which both the first halosilane compound and the second halosilane compound remain fluid (i.e., gas or liquid). Preferably, the reaction is carried out at a temperature of about −50° C. or more, about −25° C. or more, about −20° C. or more, about 31 10° C. or more, about −5° C. or more, about 0° C. or more, about 5° C. or more, about 10° C. or more, about 15° C. or more, or about 20° C. or more. At the upper end, the reaction vessel can be maintained at and the reaction is carried out any suitable temperature, though the temperature should not be so great that the first halosilane compound and/or the second halosilane compound decompose (i.e., the reaction vessel is maintained at and the reaction is carried out at a temperature less than the decomposition temperature of the first and second halosilane compounds). Preferably, the reaction is carried out at a temperature of about 100° C. or less, about 75° C. or less, about 70° C. or less, about 65° C. or less, about 60° C. or less, about 55° C. or less, about 50° C. or less, about 45° C. or less, about 40° C. or less, about 35° C. or less, or about 30° C. or less. Thus, in a series of preferred embodiments, the reaction is carried out at a temperature of about −50° C. to about 100° C. (e.g., about −50° C. to about 75° C., about −50° C. to about 70° C., about −50° C. to about 65° C., about −50° C. to about 60° C., about −50° C. to about 55° C., about −0° C. to about 50° C., about −50° C. to about 45° C., about −50° C. to about 40° C., about −50° C. to about 35° C., or about −50° C. to about 30° C.), about −25° C. to about 100° C. (e.g., about −25° C. to about 75° C., about −25° C. to about 70° C., about −25° C. to about 65° C., about −25° C. to about 60° C., about −25° C. to about 55° C., about −25° C. to about 50° C., about −25° C. to about 45° C., about −25° C. to about 40° C., about −25° C. to about 35° C., or about −25° C. to about 30° C.), about −20° C. to about 100° C. (e.g., about −20° C. to about 75° C., about −20° C. to about 70° C., about −20° C. to about 65° C., about −20° C. to about 60° C., about −20° C. to about 55° C., about −20° C. to about 50° C., about −20° C. to about 45° C., about −20° C. to about 40° C., about −20° C. to about 35° C., or about −20° C. to about 30° C.), about −15° C. to about 100° C. (e.g., about −15° C. to about 75° C., about −15° C. to about 70° C., about −15° C. to about 65° C., about −15° C. to about 60° C., about −15° C. to about 55° C., about −15° C. to about 50° C., about −15° C. to about 45° C., about −15° C. to about 40° C., about −15° C. to about 35° C., or about −15° C. to about 30° C.), about −10° C. to about 100° C. (e.g., about −10° C. to about 75° C., about −10° C. to about 70° C., about −10° C. to about 65° C., about −10° C. to about 60° C., about −10° C. to about 55° C., about −10° C. to about 50° C., about −10° C. to about 45° C., about −10° C. to about 40° C., about −10° C. to about 35° C., or about −10° C. to about 30° C.), about −5° C. to about 100° C. (e.g., about −5° C. to about 75° C., about −5° C. to about 70° C., about −5° C. to about 65° C., about −5° C. to about 60° C., about −5° C. to about 55° C., about −5° C. to about 50° C., about −5° C. to about 45° C., about −5° C. to about 40° C., about −5° C. to about 35° C., or about −5° C. to about 30° C.), about 0° C. to about 100° C. (e.g., about 0° C. to about 75° C., about 0° C. to about 70° C., about 0° C. to about 65° C., about 0° C. to about 60° C., about 0° C. to about 55° C., about 0° C. to about 50° C., about 0° C. to about 45° C., about 0° C. to about 40° C., about 0° C. to about 35° C., or about 0° C. to about 30° C.), about 5° C. to about 100° C. (e.g., about 5° C. to about 75° C., about 5° C. to about 70° C., about 5° C. to about 65° C., about 5° C. to about 60° C., about 5° C. to about 55° C., about 5° C. to about 50° C., about 5° C. to about 45° C., about 5° C. to about 40° C., about 5° C. to about 35° C., or about 5° C. to about 30° C.), about 10° C. to about 100° C. (e.g., about 10° C. to about 75° C., about 10° C. to about 70° C., about 10° C. to about 65° C., about 10° C. to about 60° C., about 10° C. to about 55° C., about 10° C. to about 50° C., about 10° C. to about 45° C., about 10° C. to about 40° C., about 10° C. to about 35° C., or about 10° C. to about 30° C.), about 15° C. to about 100° C. (e.g., about 15° C. to about 75° C., about 15° C. to about 70° C., about 15° C. to about 65° C., about 15° C. to about 60° C., about 15° C. to about 55° C., about 15° C. to about 50° C., about 15° C. to about 45° C., about 15° C. to about 40° C., about 15° C. to about 35° C., or about 15° C. to about 30° C.), or about 20° C. to about 100° C. (e.g., about 20° C. to about 75° C., about 20° C. to about 70° C., about 20° C. to about 65° C., about 20° C. to about 60° C., about 20° C. to about 55° C., about 20° C. to about 50° C., about 20° C. to about 45° C., about 20° C. to about 40° C., about 20° C. to about 35° C., or about 20° C. to about 30° C.).

The temperature of the reaction vessel and the reaction can be maintained at the desired level using any suitable means. For example, the reactor vessel can be fitted with a refrigeration/cooling unit, a heat exchanger, heating elements, or combination thereof connected to a temperature control unit. Such cooling, heat exchanging, and/or heating equipment can be fitted to the outside of the reaction vessel (e.g., disposed on the exterior surface of the reaction vessel) or they may be disposed within the interior volume of the reaction vessel. As will be understood by those skilled in the art, larger volume reaction vessels may require equipment disposed within the interior volume to better control the temperature of reactants within the reaction vessel.

The reaction vessel can be maintained at any suitable pressure. For example, the pressure in the reaction vessel can be maintained at a level that is below ambient atmospheric pressure, at a level that is substantially equal to ambient atmospheric pressure, or at a level that is above ambient atmospheric pressure. Typically, the pressure in the reaction vessel is maintained at or above the ambient atmospheric pressure. Preferably, the pressure in the reaction vessel is about 6.5 kPa or more, about 32.5 kPa or more, or about 65 kPa or more above ambient atmospheric pressure. Preferably, the pressure in the reaction vessel is about 350 kPa or less, about 280 kPa or less, or about 210 kPa or less above ambient atmospheric pressure. In a series of preferred embodiment, the pressure in the reaction vessel is about 6.5 kPa to about 350 kPa (e.g., about 6.5 kPa to about 280 kPa, or about 6.5 kPa to about 210 kPa) above ambient atmospheric pressure, about 32.5 kPa to about 350 kPa (e.g., about 32.5 kPa to about 280 kPa, or about 32.5 kPa to about 210 kPa) above ambient atmospheric pressure, or about 65 kPa to about 350 kPa (e.g., about 65 kPa to about 280 kPa, or about 65 kPa to about 210 kPa) above ambient atmospheric pressure.

The first halosilane compound can be fed into the reaction vessel at any suitable rate. Since the reaction vessel is a closed system, the product stream (e.g., a mixture of second halosilane compound and unreacted first halosilane compound) is pushed out of the inlet as additional first halosilane compound is fed into the reaction vessel. Thus, the first halosilane compound is fed into the reaction vessel at a rate that provides sufficient residence time for the reaction between the first halosilane compound and halide source to proceed. Preferably, the residence time in the reaction vessel is about 30 second or more, about 60 seconds or more, about 90 second or more, about 120 seconds or more, about 150 seconds or more, about 180 seconds or more, about 210 seconds or more, or about 240 seconds or more. The reactants can remain in the reaction vessel for any suitable amount of time. However, in those embodiment intended to maximize throughput of the method, the residence time in the reaction vessel should not be too long. Preferably, the residence time is about 4,000 seconds or less (e.g., about 3,600 seconds or less), about 3,000 seconds or less, about 2,500 seconds or less, about 2,000 seconds or less, about 1,500 seconds or less, about 1,000 seconds or less, about 900 seconds or less, about 840 seconds or less, about 780 seconds or less, about 720 seconds or less, about 660 seconds or less, or about 600 seconds or less. Thus, in a series of embodiments, the residence time in the reaction vessel preferably is about 30 seconds to about 4,000 seconds (e.g., about 30 seconds to about 3,600 seconds, about 30 seconds to about 3,000 seconds, about 30 seconds to about 2,500 seconds, about 30 seconds to about 2,000 seconds, about 30 seconds to about 1,500 seconds, about 30 seconds to about 1,000 seconds, about 30 seconds to about 900 seconds, about 30 seconds to about 840 seconds, about 30 seconds to about 780 seconds, about 30 seconds to about 720 seconds, about 30 seconds to about 660 seconds, or about 30 seconds to about 600 seconds), about 60 seconds to about 4,000 seconds (e.g., about 60 seconds to about 3,600 seconds, about 60 seconds to about 3,000 seconds, about 60 seconds to about 2,500 seconds, about 60 seconds to about 2,000 seconds, about 60 seconds to about 1,500 seconds, about 60 seconds to about 1,000 seconds, about 60 seconds to about 900 seconds, about 60 seconds to about 840 seconds, about 60 seconds to about 780 seconds, about 60 seconds to about 720 seconds, about 60 seconds to about 600 seconds, or about 60 seconds to about 600 seconds), about 90 seconds to about 4,000 seconds (e.g., about 90 seconds to about 3,600 seconds, about 90 seconds to about 3,000 seconds, about 90 seconds to about 2,500 seconds, about 90 seconds to about 2,000 seconds, about 90 seconds to about 1,500 seconds, about 90 seconds to about 1,000 seconds, about 90 seconds to about 900 seconds, about 90 seconds to about 840 seconds, about 90 seconds to about 780 seconds, about 90 seconds to about 720 seconds, about 90 seconds to about 600 seconds, or about 90 seconds to about 600 seconds), about 120 seconds to about 4,000 seconds (e.g., about 120 seconds to about 3,600 seconds, about 120 seconds to about 3,000 seconds, about 120 seconds to about 2,500 seconds, about 120 seconds to about 2,000 seconds, about 120 seconds to about 1,500 seconds, about 120 seconds to about 1,000 seconds, about 120 seconds to about 900 seconds, about 120 seconds to about 840 seconds, about 120 seconds to about 780 seconds, about 120 seconds to about 720 seconds, about 120 seconds to about 600 seconds, or about 120 seconds to about 600 seconds), about 180 seconds to about 4,000 seconds (e.g., about 180 seconds to about 3,600 seconds, about 180 seconds to about 3,000 seconds, about 180 seconds to about 2,500 seconds, about 180 seconds to about 2,000 seconds, about 180 seconds to about 1,500 seconds, about 180 seconds to about 1,000 seconds, about 180 seconds to about 900 seconds, about 180 seconds to about 840 seconds, about 180 seconds to about 780 seconds, about 180 seconds to about 720 seconds, about 180 seconds to about 600 seconds, or about 180 seconds to about 600 seconds), or about 240 seconds to about 4,000 seconds (e.g., about 240 seconds to about 3,600 seconds, about 240 seconds to about 3,000 seconds, about 240 seconds to about 2,500 seconds, about 240 seconds to about 2,000 seconds, about 240 seconds to about 1,500 seconds, about 240 seconds to about 1,000 seconds, about 240 seconds to about 900 seconds, about 240 seconds to about 840 seconds, about 240 seconds to about 780 seconds, about 240 seconds to about 720 seconds, about 240 seconds to about 600 seconds, or about 240 seconds to about 600 seconds).

In the reaction vessel, the first halosilane compound intimately contacts the halide source as the first halosilane compound passes from the inlet, through the interior volume, and towards the outlet of the reaction vessel. While in contact with the halide source, some of the first halosilane compound and the halide source react to exchange a halogen. In particular, a halogen from the first halosilane compound is exchanged for a halogen with a higher atomic number from the halide source. The result is a new halosilane compound (a second halosilane compound) that comprises at least one halogen that (i) has a higher atomic number than a halogen contained in the first halosilane compound and (ii) is covalently bound to a silicon atom of the halosilane compound.

During the reaction, the halide source can be agitated within the reaction vessel while the first halosilane compound is fed through the reaction vessel. It is believed that agitating the halide source may increase the rate of reaction within the vessel and thereby increase the yield for a given residence time within the reaction vessel. The halide source can be agitated by any suitable means or mechanism. For example, the reaction vessel can contain a stirring mechanism (e.g., paddle stirrer) disposed within the interior volume of the reaction vessel.

While the first halosilane compound has an appreciable residence time in the reaction vessel, the residence time may not be sufficient for all the first halosilane compound to react to form the second halosilane compound. Further, if the first halosilane compound contains two or more halogens to be exchanged, fewer than all those halogens may be exchanged with a single pass through the reaction vessel. Thus, in one preferred embodiment, the product stream exiting the reaction vessel can be collected and reacted a second time. For example, the product stream can be collected and passed a second time through the same reaction vessel. Alternatively, the product stream can be collected and passed through a second reaction vessel connected in series to the first reaction vessel. In such embodiments, the entire product stream can be reacted a second time, or the desired second halosilane compound can be first isolated from the product stream and the remainder of the product stream reacted a second time. Accordingly, in another preferred embodiment, the method entails the recovery of unreacted first halosilane compound from the product stream exiting the outlet of the reaction vessel. The recovered unreacted first halosilane compound can then be fed into the inlet of the reaction vessel. In such an embodiment, the method further comprises the additional steps of: (e) recovering unreacted first halosilane compound from the product stream; and (f) feeding recovered unreacted first halosilane compound into the inlet of the reaction vessel. In such an embodiment, the recovered unreacted first halosilane compound can be fed into the inlet alone or it can be mixed with fresh first halosilane compound (i.e., first halosilane compound that has not previously been passed through the reaction vessel.) Additionally, if the product stream contains intermediate halosilane compounds (e.g., halosilane compounds in which fewer than the desired number of halogens have been exchanged), these intermediate halosilane compounds can likewise be recovered from the product stream and fed back into the reaction vessel. These intermediate halosilane compounds can be fed into the inlet alone or can be mixed with fresh first halosilane compound.

The unreacted first halosilane compound and/or intermediate halosilane compounds can be recovered from the product stream by any suitable method. Because the molar mass of the halosilane compound increases as the halogen(s) are exchanged for higher atomic number halogens, the boiling point of unreacted first halosilane compound and/or intermediate halosilane compounds typically is lower than the boiling point of any desired halosilane compounds contained in the product stream. Given this difference in boiling points, the unreacted first halosilane compound and/or intermediate halosilane compounds can be recovered from the product stream by distillation. Any suitable distillation process can be used, such as flash (equilibrium) distillation, fractional distillation, or a combination of the two performed in series. For example, the unreacted first halosilane compound and/or intermediate halosilane compounds can be recovered from the product stream by a first fractional distillation of the product stream followed by a second fractional distillation of the “bottoms” from the first fractional distillation. Preferably, the unreacted first halosilane compound and/or intermediate halosilane compounds are recovered from the product stream by first flash distilling the product stream and then fractional distilling of the “bottoms” from the flash distillation. The bottoms from such distillation would contain the desired second halosilane compound, while the distillate from each distillation step would contain the unreacted first halosilane compound and/or intermediate halosilane compounds. Once the bottoms are recovered from the distillation of the product stream exiting the reactor, those bottoms can be further processed to isolate and purify the second halosilane compound contained therein. For example, the bottoms recovered from the distillation of the product stream can be processed in a subsequent fractional distillation to isolate the second halosilane compound as a distillate, thereby separating the second halosilane compound from metals or other higher boiling impurities contained in the bottoms.

As noted above, the second halosilane compound(s) produced by the reaction comprise at least one halogen that (i) has a higher atomic number than a halogen contained in the first halosilane compound and (ii) is covalently bound to a silicon atom of the halosilane compound. Thus, halosilane compounds produced by the reaction include, but are not limited to halosilane compounds of Formula (IA), Formula (XA), Formula (XXA), (Formula XXLA) as shown below. The structure of Formula (IA) is

SiₐH_{b}R_{c}X¹_{d} Formula (IA).

In the structure of Formula (IA), the variables a, b, c, and d are as described above for the compound of Formula (I). The structure of Formula (XA) is

N(SiHₑR_{f}X¹_{g})₃ Formula (XA).

In the structure of Formula (XA), the variables e, f, and g are as described above for the compound of Formula (X). The structure of Formula (XXA) is

(SiHₛRₜX¹ᵥ)₂CH₂ Formula (XXA).

In the structure of Formula (XXA), the variables s, t, and v are as described above for the compound of Formula (XX). The structure of Formula (XLA) is

(HₘRₙX¹ₚSiO)_{q}SiHₘRₙX¹ₚ Formula (XLA).

In the structure of Formula (XLA), the variables m, n, p, and q are as described above for the compound of Formula (XL).

In the structures of Formula (IA), Formula (XA), Formula (XXA), and Formula (XLA), each R, Z, and R¹ is as described above for the compounds of Formula (I), Formula (X), Formula (XX), and Formula (XLA). In the structures of Formula (IA), Formula (XA), Formula (XXA), and Formula (XLA), each X¹ is independently selected from chlorine, bromine and iodine, provided at least one X¹ has a higher atomic number than at least one X present in the first halosilane compound. In a preferred embodiment, each R group is independently selected from the group consisting of alkyl groups (e.g., C₁-C₁₀ alkyl groups). More preferably, each R group is independently selected from the group consisting of C₁-C₄ alkyl groups, with methyl groups being particularly preferred. In another preferred embodiment, each R¹ group is independently selected from the group consisting of alkyl groups (e.g., C₁-C₁₀ alkyl groups). More preferably, each R¹ group is independently selected from the group consisting of C₁-C₄ alkyl groups, with methyl groups being particularly preferred. In a preferred embodiment, the second halosilane compound of Formula (IA), Formula (XA), or Formula (XXA) contains at least one X¹ that is iodine.

Suitable examples of the second halosilane compound include, but are not limited to, chlorobromosilane, chloroiodosilane, dibromosilane, diiodosilane, chlorobromodisilanes (e.g., tetrachlorobromodisilane), chloroiododisilanes (e.g., tetrachloroiododilane), bromodisilanes (e.g., pentabromodisilane), iododisilanes (e.g., pentaiododisilane), 1-bromo-N,N-disilyl-silanamine, 1-iodo-N,N-disilyl-silanamine, alkylbromosilanes (e.g., bromotrimethylsilane), alkylchlorobromosilanes (e.g., methylchlorobromosilane), alkylchloroiodosilanes (e.g., methylchloroiodosilane), alkyldibromosilanes (e.g., methyldibromosilane), alkyldiiodosilanes (e.g., methyldiiodosilane), dialkylchlorobromosilanes (e.g., dimethylchlorobromosilane), dialkylchloroiodosilanes (e.g., dimethylchloroiodosilane), dialkyldibromosilanes (e.g., dimethyldibromosilane), dialkyldiiodosilanes (e.g., dimethyldiiodosilane), trialkyliodosilanes (e.g., iodotrimethylsilane), haloarylsilanes (e.g., dichloroiodophenylsilane, chloroiodophenylsilane, triiodophenylsilane, iodomethylphenylvinylsilane), and haloalkyldisiloxanes (e.g., chloroiodotetramethyldisiloxane, diiodotetramethyldisiloxane).

The method and reaction described above can be performed with or without a solvent. As used in this context, the term “solvent” is used to refer to an external substance or material (i.e., a substance or material that is neither a reactant used in the reaction/process nor a product produced by the reaction/process) that is used to dissolve, disperse, or suspend the reactants used in the process or the products produced by the process. In certain embodiments, it may be desirable to introduce into the reaction vessel a solvent to act as a carrier for the first halosilane compound and/or the second halosilane compound. Suitable solvents include, but are not limited to, alkanes and substituted alkanes (e.g., propane, butane, pentane, hexane, heptanes, chloromethane, dichloromethane, chloroform, carbon tetrachloride, methylene chloride, acetonitrile, and mixtures thereof). In a preferred embodiment, the method and reaction are performed without the use of alkane or substituted alkane solvents. In yet another embodiment, the method and reaction are performed without the use of any solvent, as that term has been defined above in this paragraph.

The second halosilane compound produced by the reaction is a liquid under most of the reaction conditions described herein. This liquid would normally collect on the halide source contained within the reaction vessel, making recovery of the second halosilane compound difficult to achieve without the use of solvents. However, as noted above, the method of the invention can be (and preferably is) performed without the use of solvents, as that term has been defined in the preceding paragraph. It is believed that the unique setup used in the method of the invention has obviated the need for any such solvent. In particular, by flowing the first halosilane compound through the reaction vessel, it is believed that the first halosilane compound can act as a carrier for the second halosilane compound, removing it from the reaction vessel for collection and purification. Further, since the carrier that removes the second halosilane compound is a reactant used in making the second halosilane compound, the method of the invention avoids the introduction of an external substance that must be separated from the desired second halosilane compound. Thus, the method of the invention simplifies the subsequent separation and purification of the second halosilane compound.

The method of the invention can be used to produce the target halosilane compound at relatively high purity. In this context, the purity of the target halosilane compound(s) are determined after the unreacted first halosilane compound and any intermediate halosilane compounds have been recovered from the product stream as described above. Preferably, the target halosilane compound(s) have a purity (mol./mol.) of about 95% or more, about 96% or more, about 97% or more, about 98% or more, about 99% or more, or about 99.5% or more. While not wishing to be bound to any particular theory, it is believed that the target halosilane compound(s) can be produced in such high purity because the method and reaction described herein provides relatively few pathways by which undesirable side products can be produced. Also, avoiding the use of solvents (e.g., organic solvents) is believed to contribute to the high purities achieved by the process described above. Solvents contain impurities which can contaminate the target halosilane compound(s) produced by the reaction. When a solvent is used, the solvent itself and the impurities introduced thereby must be removed from the target halosilane product. The type and number of purification steps required to achieve the desired purity will depend on the particular solvent used and the type and amount of each impurity introduced by the solvent. Thus, avoiding the use of solvent(s) simplifies the process of isolating and recovering the target halosilane compound(s) at the desired high purity levels described above.

The following examples further illustrate the subject matter described above but, of course, should not be construed as in any way limiting the scope thereof.

### EXAMPLE 1

This example demonstrates a method of the invention in which dichlorosilane is converted to diiodosilane.

A jacketed vertical stainless-steel tube, measuring 29 inches long with a diameter of 0.5 inches, was plumbed from the top outlet to a glass round bottom flask with a skin temperature maintained at 100° C. The flask was equipped with a tap water condenser which was vented to a dry ice cooled stainless steel canister. The tube jacket was maintained at 25° C. by recirculating a temperature controlled fluid. The system was purged with nitrogen and the tube was loaded with 80 g of anhydrous lithium iodide. 203 g of dichlorosilane was fed to the bottom end of the tube at such a rate as to achieve a residence time inside of the tube of 6.4 minutes while maintaining a back pressure of 10-30 psig. Once the internal temperature of the eluent flask was within 5° C. of the skin temperature the mixture was transferred to a distillation apparatus consisting of a round bottom flask equipped with a magnetic stirrer, and fitted with an 8 inch column packed with glass packing. The distillation column was equipped with a tap water condenser. The pressure of the distillation system was reduced to 30 mmHg and the pot was heated until the temperature above the column began to rise indicating the complete removal of dichlorosilane. 64.5 g of diiodosilane was isolated from the distillation bottom in 99.8% purity as indicated by GC-TCD.

### EXAMPLE 2

This example demonstrates a method of the invention in which dichlorosilane is converted to diiodosilane.

A jacketed vertical stainless-steel tube, measuring 29 inches long with a diameter of 0.5 inches, was plumbed from the bottom outlet to a glass round bottom flask with a skin temperature maintained at 100° C. The flask was equipped with a tap water condenser which was vented to a dry ice cooled stainless steel canister. The tube jacket was maintained at 25° C. by recirculating a temperature controlled fluid. The system was purged with nitrogen and the tube was loaded with 80 g of anhydrous lithium iodide. 579 g of dichlorosilane was fed to the top end of the tube at such a rate as to achieve a residence time inside of the tube of 5.2 minutes while maintaining a back pressure of 10-30 psig. Once the internal temperature of the eluent flask was within 5° C. of the skin temperature the mixture was transferred to a distillation apparatus consisting of a round bottom flask equipped with a magnetic stirrer, and fitted with an 8 inch column packed with glass packing. The distillation column was equipped with a tap water condenser. The pressure of the distillation system was reduced to 30 mmHg and the pot was heated until the temperature above the column began to rise indicating the complete removal of dichlorosilane. 81.5 g of diiodosilane was isolated from the distillation bottom in 98.5% purity as indicated by GC-TCD.

### EXAMPLE 3

This example demonstrates a method of the invention in which dichlorosilane is converted to diiodosilane.

A jacketed vertical stainless-steel tube, measuring 29 inches long with a diameter of 0.5 inches, was plumbed from the bottom outlet to a glass round bottom flask with a skin temperature maintained at 100° C. The flask was equipped with a tap water condenser which was vented to a dry ice cooled stainless steel canister. The tube jacket was maintained at −6° C. by recirculating a temperature controlled fluid. The system was purged with Nitrogen and the tube was loaded with 80 g of anhydrous lithium iodide. 416 g of dichlorosilane was fed to the top end of the tube at such a rate as to achieve a residence time inside of the tube of 4.9 minutes while maintaining a back pressure of 10-30 psig. Once the internal temperature of the eluent flask was within 5° C. of the skin temperature the mixture was transferred to a distillation apparatus consisting of a round bottom flask equipped with a magnetic stirrer, and fitted with an 8 inch column packed with glass packing. The distillation column was equipped with a tap water condenser. The pressure of the distillation system was reduced to 30 mmHg and the pot was heated until the temperature above the column began to rise indicating the complete removal of dichlorosilane. 45.2 g of diiodosilane was isolated from the distillation bottom in 99.4% purity as indicated by GC-TCD.

### EXAMPLE 4

This example demonstrates a method of the invention in which dichlorosilane is converted to diiodosilane.

A jacketed vertical stainless-steel tube, measuring 29 inches long with a diameter of 0.5 inches, was plumbed from the bottom outlet to a glass round bottom flask with a skin temperature maintained at 100° C. The flask was equipped with a tap water condenser which was vented to a dry ice cooled stainless steel canister. The tube jacket was maintained at 40° C. by recirculating a temperature controlled fluid. The system was purged with nitrogen and the tube was loaded with 80 g of anhydrous lithium iodide. 402 g of dichlorosilane was fed to the top end of the tube at such a rate as to achieve a residence time inside of the tube of 4.8 minutes while maintaining a back pressure of 10-30 psig. Once the internal temperature of the eluent flask was within 5° C. of the skin temperature the mixture was transferred to a distillation apparatus consisting of a round bottom flask equipped with a magnetic stirrer, and fitted with an 8 inch column packed with glass packing. The distillation column was equipped with a tap water condenser. The pressure of the distillation system was reduced to 30 mmHg and the pot was heated until the temperature above the column began to rise indicating the complete removal of dichlorosilane. 45.3 g of diiodosilane was isolated from the distillation bottom in 99.7% purity as indicated by GC-TCD.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

What is claimed is:

1. A method for producing halosilane compounds, the method comprising the steps of:
(a) providing a first halosilane compound, the first halosilane compound comprising a first halogen covalently bound to a silicon atom;
(b) providing a reaction vessel having an inlet, an outlet, and an interior volume, the reaction vessel containing a halide source disposed in the interior volume, the halide source comprising a second halogen having a greater atomic number than the first halogen;
(c) feeding the first halosilane compound into the inlet of the reaction vessel and through the interior volume of the reaction vessel so that it contacts the halide source and reacts to form a second halosilane compound, the second halosilane compound comprising at least one second halogen covalently bound to a silicon atom; and
(d) collecting a product stream from the outlet of the reaction vessel, the product stream comprising the second halosilane compound.

2. The method of claim 1, wherein the method further comprises the steps of:
(e) recovering unreacted first halosilane compound from the product stream; and
(f) feeding recovered unreacted first halosilane compound into the inlet of the reaction vessel.

3. The method of claim 1, wherein the first halosilane compound is fluid when fed into the inlet of the reaction vessel.

4. The method of claim 1, wherein the halide source is selected from the group consisting of anhydrous bromide salts, anhydrous iodide salts, and mixtures thereof.

5. The method of claim 1, wherein the halide source is selected from the group consisting of alkali metal halides, alkaline earth metal halides, and mixtures thereof.

6. The method of claim 4, wherein the halide source is an anhydrous iodide salt.

7. The method of claim 6, wherein the halide source is lithium iodide.

8. The method of claim 1, wherein the reaction is carried out at a temperature of about 0° C. to about 40° C.

9. The method of claim 8, wherein the reaction is carried out at a temperature of about 20° C. to about 30° C.

10. The method of claim 1, wherein the first halosilane compound is selected from the group consisting of chlorosilanes, bromosilanes, and mixtures thereof.

11. The method of claim 1, wherein the first halosilane compound is a compound of Formula (I), Formula (X), Formula (XX) or (Formula (XL)
SiₐH_{b}R_{c}X_{d} Formula (I)
wherein the variable a is an integer from 1 to 3, the sum of variables b, c, and d is 2a+2, the variable b is an integer from 0 to 2a+1, the variable c is an integer from 0 to 2a+1, and the variable d is an integer from 1 to 2a+2;
N(SiHₑR_{f}X_{g})₃ Formula (X)
wherein the sum of e, f, and g attached to each silicon atom is equal to 3, each variable e is an independently selected integer from 0 to 3, each variable f is an independently selected integer from 0 to 3, and each variable g is an independently selected integer from 0 to 3, provided at least one variable g in Formula (X) is 1 or greater;
(SiHₛRₜXᵥ)₂CH₂ Formula (XX)
wherein the sum of s, t, and v attached to each silicon atom is equal to 3, each s is an independently selected integer from 0 to 3, each variable t is an independently selected integer from 0 to 3, and each variable v is an independently selected integer from 0 to 3, provided at least one variable v in Formula (X) is 1 or greater;
(HₘRₙXₚSiO)_{q}SiHₘRₙXₚ Formula (XL)
wherein the sum of m, n, and p attached to each silicon atom is equal to 3, each m is an independently selected integer from 0 to 3, provided at least one variable m is 1 or greater, each variable n is an independently selected integer from 0 to 3, each variable p is an independently selected integer from 0 to 3, provided at least one variable p is 1 or greater, and the variable q is an integer from 1 to 50; and
wherein each R is independently selected from the group consisting of hydrocarbyl groups and ZR¹₃ groups, each Z is independently selected from silicon and germanium, and each R¹ is independently selected from hydrogen and hydrocarbyl groups; and each X is independently selected from chlorine and bromine.

12. The method of claim 11, wherein the variable b is an integer from 1 to 2a+1.

13. The method of claim 11, wherein at least one variable e in Formula (X) is 1 or greater.

14. The method of claim 11, wherein at least one variable s in Formula (XX) is 1 or greater.

15. The method of claim 11, wherein each R group is an independently selected alkyl group.

16. The method of claim 15, wherein each R group is an independently selected C₁-C₄ alkyl group.

17. The method of claim 11, wherein the first halosilane compound is dichlorosilane.

18. The method of claim 11, wherein the first halosilane compound is pentachlorodisilane.

19. The method of claim 11, wherein the first halosilane compound is 1-chloro-N,N-disilyl-silanamine.

20. The method of claim 11, wherein the first halosilane compound is an alkyldichlorosilane.

21. The method of claim 20, wherein the first halosilane compound is methyldichlorosilane.

22. The method of claim 11, wherein the first halosilane compound is a dialkyldichlorosilane.

23. The method of claim 22, wherein the first halosilane compound is dimethyldichlorosilane.
